(19) United States
(12) Patent Application Publication
(10) Pub. No.: US 2007/0035490 A1
(43) Pub. Date: Feb. 15, 2007

(54) Color display screen comprising a plurality of cells

(75) Inventors: Mark Thomas Johnson, Eindhoven (DE); Peter Alexander Duine, Eindhoven (NL); Arnoldus Theodorus Martinus Hendricus Van Keersop, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/572,928

(22) PCT Filed: Sep. 16, 2004
(86) PCT No.: PCT/IB04/51778

§ 371 Date: Mar. 22, 2006

(30) Foreign Application Priority Data
Sep. 25, 2003 (EP) 03103556.1

(51) Int. Cl. G09G 3/30

(52) U.S. Cl. 345/81

(57) ABSTRACT

A color display screen has a plurality of cells (2). Each cell (2) has a pixel (P) capable of providing a first output light of a first color and a second output light of a second color and a photosensitive device (D) for converting an optical display control signal (Li) into electrical signals (1). The optical display control signal (Li) includes information about the first output light and the second output light to control the first output light and the second output light. The photosensitive device (D) includes a decoder (DM) for decoding the information about the first and the second output light.

The invention relates to a color display screen comprising a plurality of cells. The invention also relates to a color display system having a color display screen comprising a plurality of cells, and to a set of color display screens.

GB 2 118 803 A discloses a display device comprising a light source and an image-intensifying screen. The screen comprises a plurality of cells, each having an electro luminescent emitter and a photosensitive device. The light source scans the array of photocells with a scanning laser, thereby illuminating with its beam each photosensitive device to a different degree according to an image to be displayed on the screen. In dependence on the illumination the photosensitive device is arranged to control the light output of the emitter. In a horizontal direction along lines of the screen sets of cells with emitters generating red, green and blue light, respectively are located. When the lasers scans a line of the screen it has to provide an illumination corresponding to successive amounts of light output that the successive emitters for red, green and blue light have to generate. This requires a rapid switching of the light source while the laser scans successive cells. Moreover, an accurate tracking is required between the position of the beam of the laser on the screen and the rapid switching of the laser output to the levels corresponding with the desired illumination of the successive cells. To obtain an adequate tracking, a tracking system is required to provide feedback to the light source about the position of the laser on the screen. It is a disadvantage of the display device that a tracking system is required to ensure correct reproduction of images on the screen.

It is an object of the invention to provide a color display screen of the kind described in the opening paragraph, which obviates a tracking system.

The object is realized in that each cell comprises a pixel capable of providing a first output light of a first color and a second output light of a second color, and a photosensitive device for converting an optical display control signal comprising information about the first output light and the second output light into electrical signals to control the first output light and the second output light, the photosensitive device having decoding means for decoding the information about the first and the second output light. As the photosensitive device has means for decoding the information, the device is able to determine which output light has to be controlled with the information comprised in an optical image control signal received by the device. So, there is no need of providing tracking between the position of the optical image control signal and the cells on the screen. The optical image control signal may be a scanning beam, which, for example, scans repeatedly line by line the screen, or may even originate from a source, which generates simultaneously the optical image control signal for each of the cells to be controlled. As long as the diameter of the optical image control signal on the screen is larger that a pitch of the photosensitive devices, the photosensitive devices are able to receive this optical image control signal and to direct the information comprised in the optical image control signal to their corresponding pixels for providing the corresponding output light. The pixel may also be capable of providing output light of more than two colors. The pixel may comprise one or more subpixels, each providing a particular color. The pixel may also comprise a multicolor subpixel, which, in dependence on its driving voltage, is capable of providing different colors.

In an embodiment, the optical display control signal comprises a first optical display control signal comprising information about the first output light and having a first spectrum, and a second optical display control signal comprising information about the second output light and having a second spectrum, the decoding means comprising a first wavelength sensitive filter for filtering the first optical display control signal and a second wavelength sensitive filter for filtering the second optical display control signal. So, if the information about the first and the second output light is encoded by using different spectra, the decoding means can be realized in a simple manner with wavelength sensitive filters. The decoding means function correctly when the first and the second optical display control signal are simultaneously present as well as when these signals are transmitted sequentially.

The cell may comprise another photosensitive device, the pixel comprising a first subpixel for providing the first output light, the first subpixel being coupled to the photosensitive device and the other photosensitive device, each having decoding means comprising a first wavelength sensitive filter. By providing more than one photosensitive device coupled to a same subpixel, the pitch between these photosensitive devices becomes smaller, thereby enabling the decoding of optical display control signals with a smaller diameter of the optical image control signal on the screen and/or increasing the electrical signals to control the corresponding output light.

In an embodiment, the optical display control signal comprises successively the information about the first output light and the second output light, the decoding means having means for activating the first output light and the second output light of the pixel in synchronization with the information as successively comprised in the optical display control signal. If the information about the first and the second output light is sequentially transmitted, then the information corresponding to a particular output light can be used for this particular output light by activating this output light in synchronization with the information as successively comprised in the optical display control signal. The means for activating the first output light and the second output light may be one common circuit for all cells or for a group of cells, which is very cost effective. The synchronization may be obtained via an optical or electrical signal receivable from a same source that provides the optical display control signal. The synchronization may also be obtained from the optical display control signal itself.

The means for activating may comprise a first switch and a second switch common to all photosensitive devices of the plurality of cells, the pixel comprising a first subpixel and a second subpixel, each of the first subpixels of the plurality of cells being coupled via the first switch to a first supply voltage, each of the second subpixels of the plurality of cells being coupled via the second switch to a second supply voltage, the first switch and the second switch being operable in synchronization with the information. By activating each of the first subpixels by coupling the first supply voltage via the first switch to these subpixels, the first subpixels are able to provide output light in dependence on the optical display control signal received by the respective photosensitive devices coupled to the first subpixels. By synchronizing the operation of the first switch such that the first supply voltage is coupled to the first subpixels, while the information about the first output light is being received, the first subpixels provide the first output light in correspondence with the information about the first output light. By at the same time synchronizing the operation of the second switch such that the second supply voltage is not coupled to the second subpixels, it is ensured that the second subpixels do not provide the second output light in response to the information about the first output light. Likewise, the second switch is closed and the first switch is opened, while the information about the second output light is received. The first supply voltage and the second supply voltage may be different voltages, but may also be one common voltage.

It is advantageous if the photosensitive device further comprises a photosensitive element, while the decoding means further comprises a reset switch for resetting the photosensitive element substantially between the information about the first output light and the second output light. By adding the reset switch, the photosensitive element may be reset to a predetermined state substantially before a start of a time period during which information about a particular output light is present in the optical display control signal. In this way the photosensitive device only provides electrical signals to the corresponding subpixel according to the information provided during that time period. So, the electrical signals during this time period are no longer dependent on earlier information, which may have altered the state of the photosensitive element.

It is advantageous if the pixel comprises a first subpixel and a second subpixel, the photosensitive element being coupled to the first subpixel, the optical display control signal comprising in a first frame period the information about the first output light and in a second frame period the information about the second output light, the decoding means being adapted for decoding during the first frame period the information about the first output light and for driving the first subpixel during the second frame period in dependence on the decoding during the first frame period. By decoding during the first frame period the information corresponding to the first output light, each photosensitive element of the plurality of cells is able to receive the information for the subpixel it is coupled to. By using this information only during a succeeding frame period for driving the corresponding subpixel, each subpixel is driven during a fixed time period, being the frame period. In case more that two different colors are transmitted, each subpixel may be driven during two or more frame periods. The driving may also be done during a frame period, wherein decoding is done. If in this case the information about a particular output light of the plurality of cells is transmitted sequentially, the duration of the driving of a particular subpixel would depend on the location of this particular subpixel information in the transmitted sequence. As a result, the amount of output light of the pixels would to some degree depend on the position of the pixel on the screen. An advantage of this last case is that each color is provided during each frame, rather than being provided sequentially. So, a potentially disturbing visibility of the successive colors, also called a color flash effect, is avoided. Moreover the dependence on the position of the pixel on the screen may be reduced in a number of ways. One way is to apply fast addressing, whereby the subpixels are firstly set to provide a desired level of output light, after which, during a predetermined time period, which is usually longer than the addressing time, the subpixels continue to provide this desired level of output. A second way is to apply preprocessing of the information about the first and the second output light, thereby taking into account differences of the duration of the time that a subpixel provides its output light in dependence on its position on the screen. A third way is to apply a scanning reset, whereby liness or groups of lines are reset sequentially and not simultaneously. Moreover it is possible to apply a combination of above-mentioned ways.

In an embodiment the information about at least one of the first output light and the second output light is a modulation of the optical display control signal and the decoding means comprise means for demodulating the modulation of the optical display control signal. In this case the source of the optical display control signal may be a monochrome source. Moreover a common reset may be applied to the plurality of cells for resetting the photosensitive device and/or the pixel before the information about an image is transmitted.

The means for demodulating the modulation may be adapted for demodulating an AC component of the optical display control signal. An AC component can easily be demodulated with simple circuitry.

The first wavelength sensitive filter may be formed by a layer of the pixel. By using the layer of the pixel as a wavelength sensitive filter, less process steps are required to manufacture the screen.

The display screen of the invention may have a front side for delivering light provided by each pixel of the plurality of cells, each photosensitive device of the plurality of cells being adapted to receive the optical display control signals from a source positioned at a side of the screen facing away from the front side. Applying rear projection has the advantage that the source of the optical display control signals is hidden behind the screen.

Alternatively the screen may be arranged for front projection, the photosensitive device being located at the front side.

The pixels may be of a type, which transmits or reflects light from a separate light source, as well as self-emissive pixels.

The photosensitive devices of the plurality of cells of the screen of the invention may be adapted to receive optical display control signals of non-visible light or visible light. When applying a source, which generates optical display control signals outside the visible light spectrum, interference between the optical display control signals and visible light modulated by the pixels in the screen is avoided. Moreover such a screen is not sensitive to ambient lighting conditions.

The invention further provides a display system comprising a color display screen as described before, and an optical image source for transmitting the optical display control signal to the photosensitive device.

The optical image source may be a projection device or a laser scanner.

The invention further provides a set of color display screens arranged adjacent to each other in a tiled pattern. As each display screen has only a small number of connections, this number being in the order of less than ten, it is relatively easy to interconnect corresponding connections of a set of displays. Due to this small number of connections it is also relatively easy to align display screens in a tiled pattern adjacent to each other.

These and other aspects of the invention will be further elucidated and described with reference to the drawings, in which:

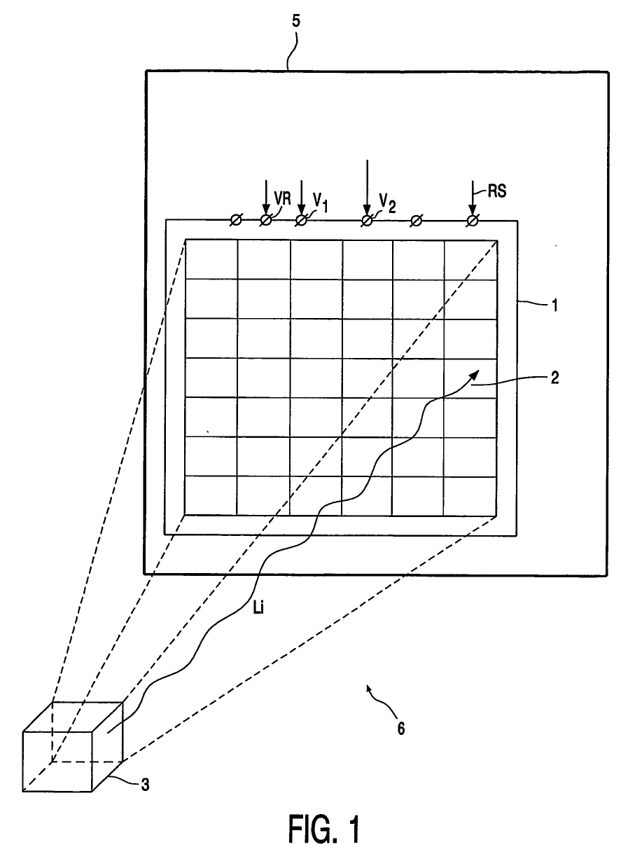

FIG. 1 shows a block diagram of an embodiment of the display system according to the invention;

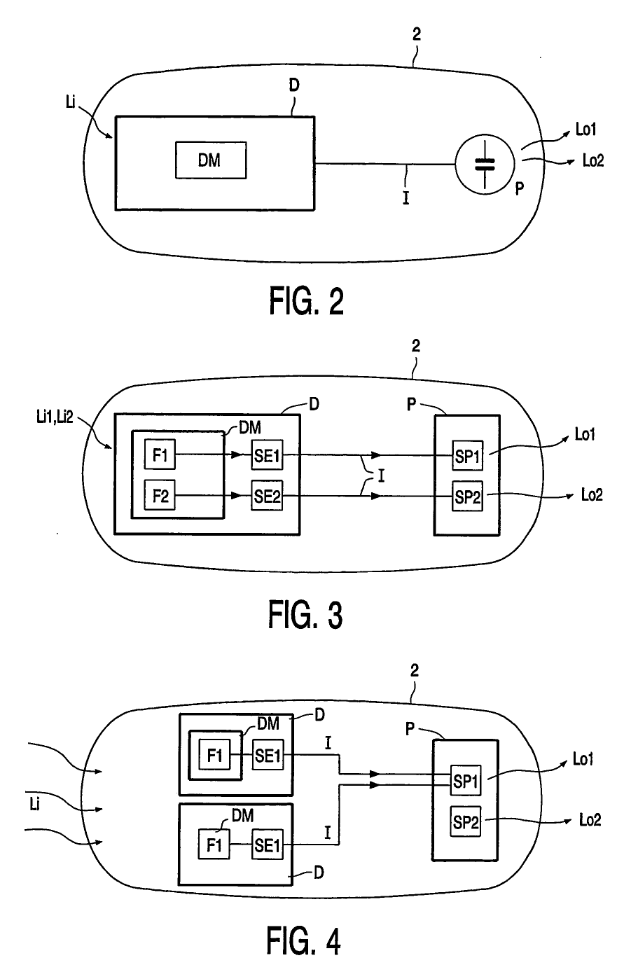

FIGS. 2 to 5 show block diagrams of embodiments of a cell applied in the display screen according to the invention;

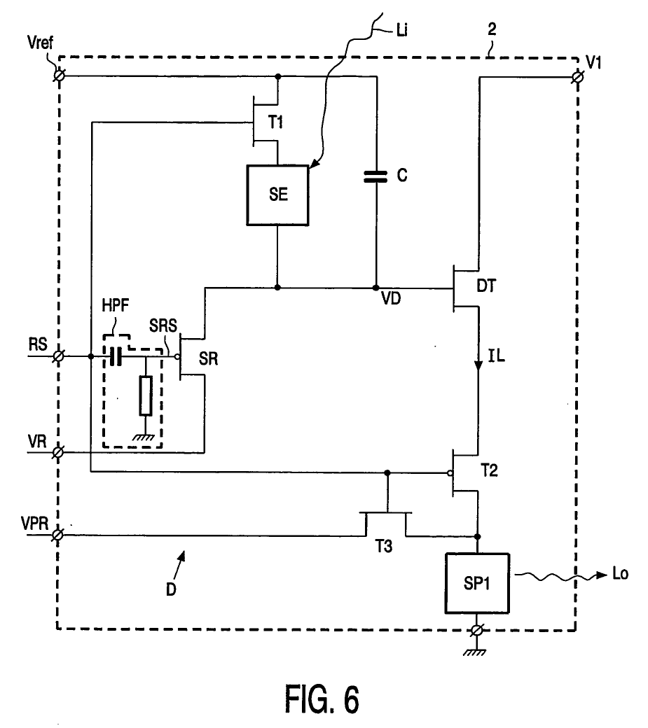

FIG. 6 shows a circuit diagram of an embodiment of a part of a cell applied in the display screen according to the invention;

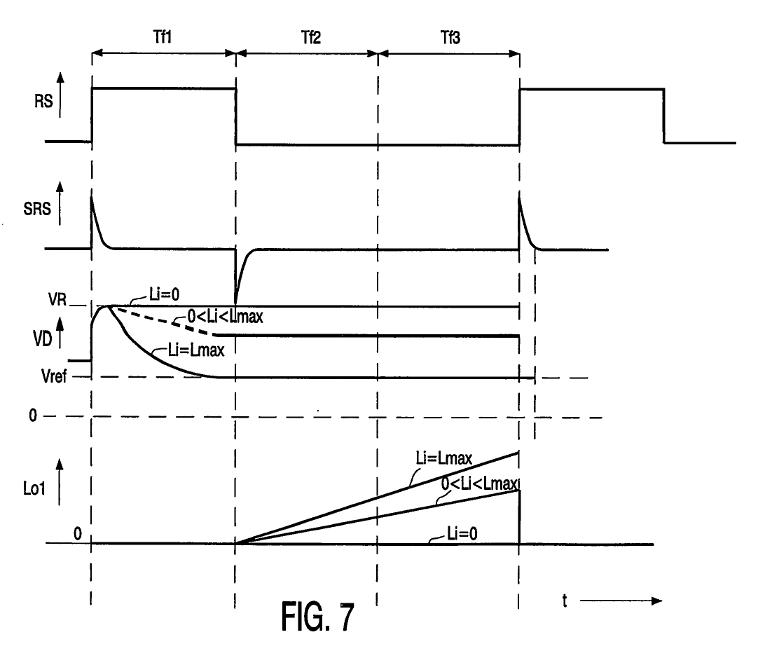

FIG. 7 shows waveforms of the diagram of FIG. 6;

FIG. 8 shows a block diagram of an embodiment of a cell applied in the display screen according to the invention;

FIG. 9 shows a circuit diagram of an embodiment of a part of the cell shown in FIG. 8; and

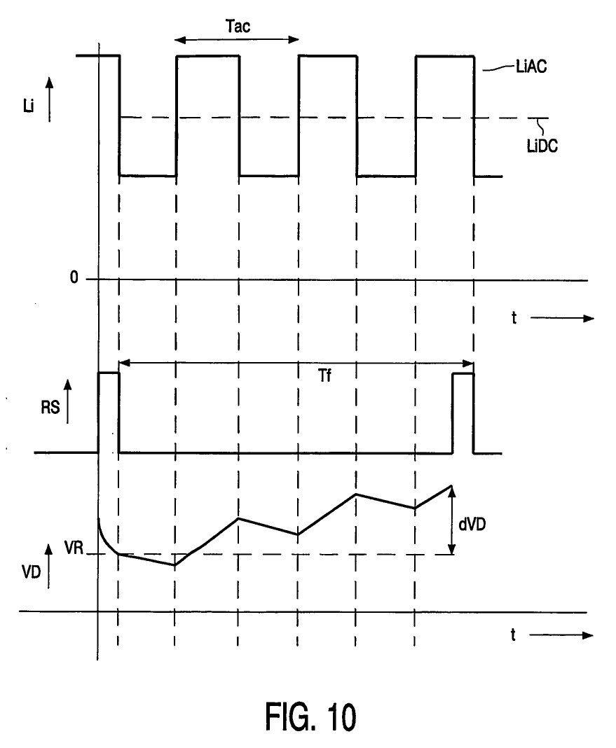

FIG. 10 shows waveforms of the diagram of FIG. 9.

The same references in different Figs. refer to the same signals or to elements performing the same function.

The display system 6 shown in FIG. 1 comprises a display screen 5 and an optical image source 3. The display screen comprises a display panel 1. The display panel 1 comprises a plurality of cells 2 arranged in a matrix of rows and columns. The panel 1 does not require any row or column electrodes as each cell 2 is addressed via an external optical image source 3. The source 3 provides an optical display control signal Li which is receivable by each of the cells 2. For this reason the cells 2 may be arranged in any arbitrary configuration, so apart from a configuration in rows and columns, also other configurations like, for example, radial, diagonal or circular configurations may be applied. The cells 2 may also have a large variety of shapes. The panel 1 has connections for receiving, for example, a reset signal RS and several voltages, such as:

a reset voltage VR,

a first supply voltage V1, and

a second supply voltage V2.

The reset signal RS and the voltages are coupled to each cell 2 of the panel 1. The operation of the display system will be explained with reference to the embodiments of the cell (2).

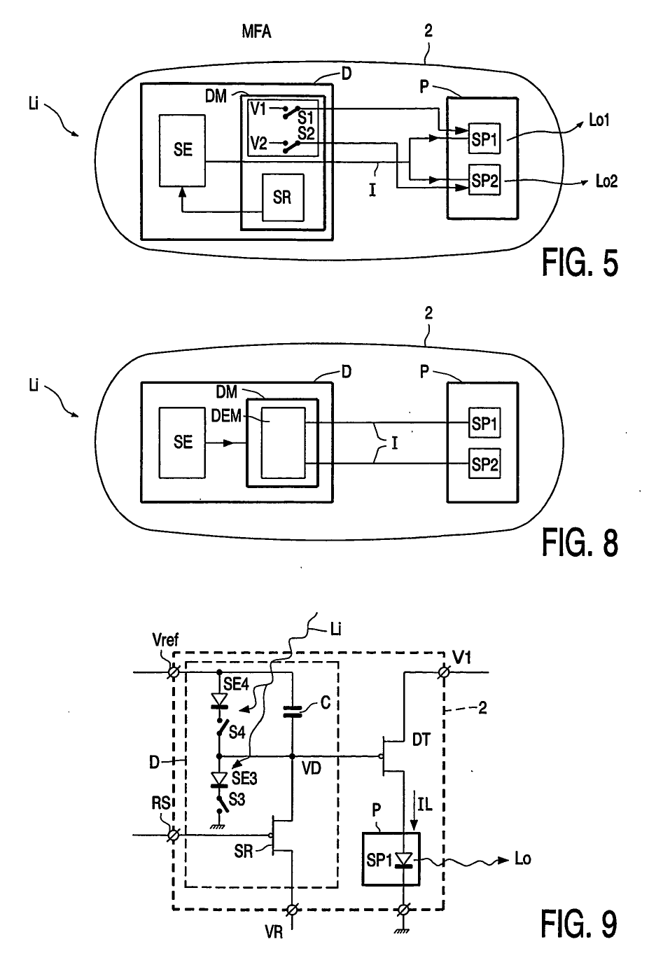

As shown in FIG. 2, a cell 2 comprises a photosensitive device D and a pixel P. The cell 2 receives an optical display control signal Li from the source 3. Via the photosensitive device D in the cell 2 the optical display control signal Li is converted into electrical signals I. The pixel P in the cell 2 provides a first output light Lo1 of a first color and a second output light Lo2 of a second color. The first and the second light output Lo1, Lo2 are controlled by the electrical signals I. The photosensitive device D further comprises decoding means DM for decoding information about the first and the second light output Lo1, Lo2 comprised in the optical display control signal Li. So, on the location where the optical display control signal Li hits the screen 5, the decoding means DM ensure that the photosensitive device provides the electrical signals I which drive the pixel P in such a way that it provides light of a desired color. This means that there is no need to align the light source 3 and the display screen 5 or to provide a tracking system in order to ensure that the optical display control signal Li hits exactly photosensitive devices coupled to a particular color. The decoding means DM (or at last an essential part thereof) may be formed by a wavelength sensitive filter as shown in FIG. 3, by decoding means for decoding a modulation of the optical display control signal Li as shown in FIG. 8, or by switches operable in synchronization with the optical display control signal Li as shown in FIG. 5.

The photosensitive device D of the cell 2 shown in FIG. 3 has decoding means DM comprising a first wavelength sensitive filter F1 and a second wavelength sensitive filter F2, each filter F1, F2 coupled to, or part of a corresponding photosensitive element SE1, SE2 of the photosensitive device D. The photosensitive element SE1, SE2 converts the optical signal Li into an electrical output signal. The optical display control signal Li comprises a first optical display control signal Li1 comprising information about the first output light and having a first spectrum, and a second optical display control signal Li2 comprising information about the second output light and having a second spectrum. The first wavelength sensitive filter F1 is adapted for filtering the first optical display control signal Li1, and the second wavelength sensitive filter F2 is adapted for filtering the second optical display control signal Li2. With filtering is meant allowing wavelengths within substantially the first spectrum, respectively the second spectrum to pass the filter and blocking wavelengths, which are substantially outside the first and the second spectrum, respectively. The photosensitive elements SE1, SE2 convert the filtered first optical display control signal Li1 and the second optical display control signal Li2 into the electrical signals I which control the pixel P. The pixel P may comprise a first subpixel SP1 for providing the first output light Lo1 and a second subpixel SP2 for providing the second output light Lo2. In this case the electrical signals I may be two separate signals, a first electrical signal originating from a first one of the photosensitive elements SE1; SE2 and corresponding to the information about the first output light, and a second electrical signal originating from a second one of the photosensitive elements SE2; SE1 and corresponding to the information about the second output light. The first electrical signal is coupled to the first subpixel SP1 for controlling the first output light Lo1 and the second electrical signal is coupled to the second subpixel SP2 for controlling the second output light Lo2. Alternatively (not shown), the pixel P may be a multicolor pixel. In this case the multicolor pixel may be controlled by a combination of the signals originating from the first and second one of the photosensitive elements SE1, SE2.

Examples of a subpixel and circuits to drive such a subpixel as well as examples of a photosensitive element are disclosed in European patent applications 03101909.4 and 03101366.7, incorporated by reference herein.

The wavelength sensitive filter may be formed by a color filter as used in a liquid crystal type display or by emissive polymers as used for color organic LED displays. In this case the optical display control signal Li should have a spectrum within the range of visible wavelengths.

The cell 2 shown in FIG. 4 has two photosensitive devices D. Each device D comprises decoding means DM with a first wavelength sensitive filter F1 coupled to a first photosensitive element SE1. The pixel P has a first subpixel SP1 and a second subpixel SP2. The electrical signals I originating from the first photosensitive element SE1 of each of the two photosensitive devices D are provided to the subpixel SP1, such that the light output Lo1 is substantially proportional to a sum of the information about the first output light as decoded by the two photosensitive devices. The cell 2 may also comprise more than two photosensitive devices D. Each photosensitive device D may include two or more different wavelength sensitive filters F1, F2 as shown in FIG. 3.

In the cell 2 shown in FIG. 5 the photosensitive device D comprises a photosensitive element SE and the decoding means DM. The decoding means DM comprise means for activating MFA the first output light Lo1 and the second output light Lo2 of the pixel P. The optical display control signal Li comprises successively the information about the first output light and information about the second output light. The photosensitive element SE converts the optical display control signal Li into an electrical output signal coupled to the means for activating MFA. The means for activating MFA may be one activating circuit MFA, which is common for each of the plurality of cells 2. The means for activating MFA activates the first output light Lo1 and the second output light Lo2 of the pixel P in synchronization with the information as successively comprised in the optical display control signal Li.

In the embodiment as shown in FIG. 5, the means for activating MFA comprises a first switch S1 and a second switch S2 common for all photosensitive devices of the plurality of cells 2. The pixel (P) comprises a first subpixel SP1 and a second subpixel SP2. Each first subpixel SP1 of the plurality of cells 2 is coupled via the first switch S1 to a first supply voltage V1. Each second subpixel SP2 of the plurality of cells 2 is coupled via the second switch S2 to a second supply voltage V2. The first switch S1 and the second switch S2 are operable in synchronization with the information about the first output light and information about the second output light comprised in the optical display control signal Li. The photosensitive devices convert this information into electrical signals I that are coupled to the first subpixel SP1 as well as the second subpixel SP2. While information about the first output light is received during a first time interval, the second subpixel SP2 is deactivated by interrupting via the second switch S2 the delivery of the second supply voltage V2 to the subpixel SP2. During this time interval the first subpixel SP1 is activated by coupling via the first switch S1 the first supply voltage V1 to the subpixel SP1. In this way is ensured that the first subpixel SP1 is controlled by the information about the first output light. In a similar way the second subpixel SP2 is controlled by the information about the second output light.

The decoding means (DM) may further comprise a reset switch SR for resetting the photosensitive element SE substantially between the information about the first output light and the second output light. Examples of circuits comprising such a photosensitive element SE and a reset switch SR are disclosed in the aforementioned European patent applications 03101909.4 and 03101366.7.

FIG. 6 shows a circuit diagram of a part of a cell 2. The cell comprises terminals for receiving a reference voltage Vref, a first supply voltage V1, another supply voltage that may be ground level, a pixel reset voltage VPR, a reset voltage VR and a reset signal RS. Between the terminal for the reference voltage Vref and a node VD a transistor T1 is coupled in series with a photosensitive element SE for receiving the optical display control signal Li. A capacitor C is coupled between the reference voltage Vref and the node VD. A main terminal of a drive transistor DT is coupled to the first supply voltage V1. A control terminal of the drive transistor DT is coupled to the node VD. Another main terminal of the drive transistor DT is coupled to a main terminal of a second transistor T2. Another main terminal of the second transistor T2 is coupled to a first terminal of a first subpixel SP1 for providing the first output light Lo1. A second terminal of the first subpixel is coupled to the ground level. The first terminal of the first subpixel is coupled to a main terminal of a third transistor T3. Another main terminal of the third transistor T3 is coupled to the pixel reset voltage VPR. A reset switch SR is coupled via its main terminals between the node VD and the reset voltage VR. The reset signal RS is coupled to control terminals of the first transistor T1, the second transistor T2 and the third transistor T3. Moreover the reset signal RS is coupled to a control terminal of the reset switch SR via a high pass filter HPF.

The operation of the embodiment of the cell 2 shown in FIG. 6 will be explained below with reference to the waveforms as function of time t as shown in FIG. 7.

During a first frame period Tf1 a transistion from a low to a high level of the reset signal SR results via the high pass filter HPF in a short pulse SRS. During the short pulse SRS the reset switch SR is closed. Via the reset switch SR the reset voltage VR, which may be a fixed voltage, is coupled to the node VD. As a result the voltage VD will quickly reach the level of the reset voltage VR. The reset voltage VR is preferably substantially equal to the first supply voltage V1, while the reference voltage Vref is preferably lower than the first supply voltage V1. Alternatively (not shown), instead of applying the high pas filter HPF to convert the reset signal, a separate reset signal may be provided corresponding to the short pulse SRS.

During the first frame period Tf1 the second transistor T2 is turned off by the reset signal RS and blocks any current originating from the drive transistor DT. The third transistor T3 is turned on by the reset signal RS and resets the voltage across the first subpixel SP1 to such a value that the first subpixel SP1 does not provide the first output light Lo1. Moreover the reset signal RS turns on the first transistor T1, thereby allowing the photosensitive element SE to discharge the capacitor C in dependence on the optical display control signal Li received by the photosensitive element. As a result, the voltage at the node VD starts to decrease after the short pulse SRS. So, the voltage at the node VD decreases during the first frame period from the reset voltage VR to a lower value in dependence on the optical display control signal Li.

When no optical display signals Li are received the capacitor C is not discharged, so the voltage at the node VD remains constant, indicated by the curve “Li=0”. When the optical display control signal Li corresponds to a maximum level Lmax, the capacitor C is substantially completely discharged during the first frame period Tf1, resulting in the curve indicated by “Li=Lmax”. When the optical display control signal Li corresponds to a level in-between zero and the maximum level Lmax, the capacitor C is partially discharged during the first frame period Tf1, resulting in the curve indicated by “0<Li<Lmax”.

During a second frame period Tf2 the reset signal RS is low, thereby keeping the first transistor T1 and the third transistor T3 turned off, while the second transistor T2 is turned on. The reset switch SR is not affected by the short negative pulse and remains open.

As a result, during the second frame period Tf2 a current IL flows through the drive transistor DT and the first subpixel SP1. This current IL depends on the voltage of the node VD. This voltage remains substantially unchanged during the second frame period Tf2 as the capaitor C keeps its charge if a current through the control terminal of the drive transistor DT is negligible. So, the drive transistor DT receives during the second frame period Tf2 at its control terminal substantially a constant voltage which is proportional to the optical display control signal Li received during the first frame period Tf1.

In case Li=Lmax, the current IL is at its maximum level during the second frame period Tf2, resulting in the first output light Lo1 of the first subpixel SP1 having a maximum level. In case Li=0, the current IL remains zero and the first subpixel SP1 does not provide the first output light Lo1. In case 0<Li<Lmax, the current IL is at an intermediate value during the second frame period Tf2, so the first subpixel SP1 provides an intermediate level of the first output light Lo1. So, the level of first output light Lo1 provided by the first subpixel SP1 during the second frame period Tf2 is proportional to the optical display control signal Li as received during the first frame period Tf1.

So, if the optical display control signal Li transmits in successive frame periods Tf1, Tf2, Tf3 information about respectively the first, the second and a third output light, then, in the embodiment of FIG. 6, the first subpixel provides the first output light Lo1 during the second frame period Tf2 and the third frame period Tf3. Likewise, a same circuit as shown in FIG. 6 receiving another reset signal RS, which has a high level during the second frame period, and having a second subpixel SP2 for providing the second output light Lo2, provides the second output light Lo2 during the third frame period Tf3 and the frame period immmediately thereafter based on the information about the second output light received during the second frame period Tf2.

Alternatively, in the circuit of FIG. 6 the second transistor T2 may be omitted, thereby coupling the drive transistor directly to the first subpixel SP1. In order to ensure that the first subpixel does not provide the output light during the first frame period Tf1, the first supply voltage V1 is disconnected during this period, for example, by means of the common first switch S1 as shown in FIG. 5.

Alternatively, the circuit of FIG. 6 may be modified by having the high level of the reset signal RS turn on the second transistor T2 and by coupling the short pulse SRS to the control terminal of the third transistor T3 instead of the reset signal RS. As a result at the start of the frame period Tf1, the voltage across the first subpixel SP1 is rapidly reset to the pixel reset voltage VPR. During the first frame period Tf1 the drive transistor is conducting, so the current IL flows through the first subpixel SP1. The current IL is dependent on the voltage at the node VD as described hereinbefore. As a result the first subpixel will be charged during the first frame period Tf1 to a level depending on the optical display control signal Li received during this first frame period Tf1. During the second and the third frame periods Tf2, Tf3 the second transistor T2 is turned off by the reset signal RS and the voltage across the first subpixel remains constant. So, during the first frame period Tf1, the first. subpixel SP1 start to provide the output light Lo1. The first subpixel SP1 continues to provide the output light Lo1 during the second and the third frame periods Tf2, Tf3 at a level reached at the end of the first frame period Tf1.

In an embodiment of the cell 2 shown in FIG. 8, the optical display control signal Li is modulated with the information about at least one of the first output light and the second output. The decoding means DM comprises means for demodulating DEM the modulation of the optical display control signal Li. The optical display control signal Li is firstly converted into an electrical output signal by the photosensitive element SE. The electrical output signal is supplied to the means for demodulating DEM. Any known method of a modulation of the optical display control signal Li and corresponding demodulation by the means for demodulation may be applied, for example amplitude modulation, pulse width modulation or pulse amplitude modulation. The demodulated output may be one or more electrical signals I coupled to the corresponding subpixels.

An embodiment of the cell 2 having decoding means DM for demodulating a pulse amplitude modulated optical display control signal Li is shown in FIG. 9. The cell 2 has terminals for receiving a reference voltage Vref coupled to the photosensitive device D and a first supply voltage V1 coupled to a main terminal of a drive transistor DT. Another main terminal of the drive transistor DT is coupled to a first terminal of a first subpixel SP1 of a pixel P. A second terminal of the first subpixel SP1 is coupled to another supply voltage, which may be ground level.

The photocell comprises a first series connection of a third switch S3 and a third photosensitive element SE3, a second series connection of a fourth switch S4 and a fourth photosensitive element SE4, a capacitor C and a reset switch SR, which may be formed by a transistor as shown in FIG. 9. The first series connection is coupled between a supply voltage, which may be ground level and a node VD. The capacitor C and the second series connection are coupled in parallel between the reference voltage Vref and the node VD. The node VD is also coupled to a first main terminal of the reset switch SR and to a control terminal of the drive transistor DT. A second main terminal of the reset switch SR is coupled to a reset voltage VR. A control terminal of the reset switch SR is coupled to a terminal for receiving a reset signal RS.

The optical display control signal Li of FIG. 9 is modulated as shown in FIG. 10. The amplitude of the optical display control signal Li as function of time t comprises a DC component LiDC and an AC component LiAC, which is a pulse modulated in amplitude. The AC component LiAC has a period time Tac that is a number of times smaller than the frame period Tf. The frame period Tf is the time period wherein the information about a complete image is transmitted via the optical display control signal Li. The reset signal RS provides a pulse to the reset switch SR before the start of a new frame period Tf. During this pulse the reset switch SR conducts and couples the reset voltage VR to the node VD. As a result the capacitor C is rapidly charged until the node VD reaches the level of the reset voltage VR. At the end of the reset pulse, the reset switch SR is turned off. The charging or discharging of the capacitor C during the remainder of the frame period Tf depends on the first and the second series connection. The third switch S3 is closed and the fourth switch S4 is opened while the optical display control signal Li has a high amplitude during the period time Tac. The third switch S3 is opened and the fourth switch S4 is closed while the optical display control signal Li has a low amplitude during the period time Tac. As a result the capacitor C is discharged while the optical display control signal Li has a low amplitude and is charged while the optical display control signal Li has a high amplitude. Depending on the ratio of the duration of the low and the high amplitude of the optical display control signal Li and on the difference between the high amplitude and the low amplitude, the capacitor C is discharged during the frame period. Thus, the voltage at the node VD has a voltage difference dVD at the end of the frame period Tf with respect to its voltage at the start of the frame period Tf. This voltage difference dVD is proportional to the difference between the high amplitude and the low amplitude of the optical display control signal Li and may be used to drive the first subpixel SP1. So, the AC component LiAC resulting in the voltage difference dVD, may be used to control the first subpixel SP1, while the DC component LIDC may be used to control another subpixel SP2 (not shown).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A color display screen (5) comprising a plurality of cells (2), each cell (2) comprising:
a pixel (P) capable of providing a first output light of a first color and a second output light of a second color; and
a photosensitive device (D) for converting an optical display control signal (Li) comprising information about the first output light and the second output light into electrical signals (I) to control the first output light and the second output light, the photosensitive device (D) having decoding means (DM) for decoding the information about the first and the second output light.

2. A color display screen (5) as claimed in claim 1, the optical display control signal (Li) comprising a first optical display control signal comprising information about the first output light and having a first spectrum, and a second optical display control signal comprising information about the second output light and having a second spectrum, the decoding means (DM) comprising a first wavelength sensitive filter for filtering the first optical display control signal, and a second wavelength sensitive filter for filtering the second optical display control signal.

3. A color display screen (5) as claimed in claim 1, each cell (2) comprising another photosensitive device (D), the pixel (P) comprising a first subpixel for providing the first output light, the first subpixel being coupled to the photosensitive device (D) and the other photosensitive device (D), each having decoding means (DM) comprising a first wavelength sensitive filter.

4. A color display screen (5) as claimed in claim 1, the optical display control signal (Li) comprising successively the information about the first output light and the second output light, the decoding means (DM) having means for activating the first output light and the second output light of the pixel (P) in synchronization with the information as successively comprised in the optical display control signal (Li).

5. A color display screen (5) as claimed in claim 4, the means for activating comprising a first switch and a second switch common to all of the photosensitive devices (D) of the plurality of cells (2), the pixel (P) comprising a first subpixel and a second subpixel, each of the first subpixels of the plurality of cells (2) being coupled via the first switch to a first supply voltage, each of the second subpixels of the plurality of cells (2) being coupled via the second switch to a second supply voltage, the first switch and the second switch being operable in synchronization with the information.

6. A color display screen (5) as claimed in claim 4, the photosensitive device (D) further comprising a photosensitive element, the decoding means (DM) further comprising a reset switch for resetting the photosenstive element substantially between the information about the first output light and the second output light.

7. A color display screen (5) as claimed in claim 6, the pixel (P) comprising a first subpixel and a second subpixel, the photosensitive element being coupled to the first subpixel, the optical display control signal (Li) comprising in a first frame period the information about the first output light and in a second frame period the information about the second output light, the decoding means (DM) being adapted for decoding during the first frame period the information about the first output light and for driving the first subpixel during the second frame period in dependence on the decoding during the first frame period.

8. A color display screen (5) as claimed in claim 1, the information about at least one of the first output light and the second output light being a modulation of the optical display control signal (Li); and the decoding means (DM) comprising means for demodulating the modulation of the optical display control signal (Li).

9. A color display screen (5) as claimed in claim 8, the means for demodulating the modulation being adapted for demodulating an AC component of the optical display control signal (Li).

10. A color display screen (5) as claimed in claim 2, the first wavelength sensitive filter being formed by a layer of the pixel (P).

11. A color display system (6) comprising a display screen (5) as claimed in claim 1, and an optical image source (3) for transmitting the optical display control signal (Li) to the photosensitive device (D).

12. A color display system (6) as claimed in claim 11, the optical image source (3) being a projection device or a laser scanner.

13. A set of color display screens (5) as claimed in claim 1, the color display screens (5) being arranged adjacent to each other in a tiled pattern.
